(19) United States
(12) Patent Application Publication
(10) Pub. No.: US 2005/0133058 A1
(43) Pub. Date: Jun. 23, 2005

(54) Dental flosser

(76) Inventor: Songjun Ding, Guangzhou (CN)

Correspondence Address: CHARLES E. BAXLEY, ESQ., 90 JOHN STREET, THIRD FLOOR, NEW YORK, NY, 10038, US

(21) Appl. No.: 11/019,835

(22) Filed: Dec. 21, 2004

(30) Foreign Application Priority Data
Dec. 23, 2003 (CN) CN 200320132054.0

(51) Int. Cl. A61C 15/00

(52) U.S. Cl. 132/323

(57) ABSTRACT

A dental floss indicating a 2D construction in its non-use status and an L-shaped construction in use includes a U-shaped holder, a floss secured and bridged between two tops of the U-shaped holder, a left handle and a right handle respectively connected to both sides at the base of the U- shaped holder; a left hinge and a right hinge made thinner and allowing easy bending being respectively provided at where both handles are connected to the U-shaped holder; a left and a right locking means being respectively provided to both of the left and the right handles; the surface each of the left and the right handles being disposed with multiple ribs; and a tail hinge being disposed at where both ends from the left and the right handles are connected to each other.

### BACKGROUND OF THE INVENTION

(a) Field of the Invention

The present invention is related to a dental care product, and more particularly, to an L-shaped dental flosser.

(b) Description of the Prior Art:

As a dental hygiene tool, a dental flosser cleans away plaque and debris from between teeth is essentially comprised of a U-shaped holder with its both tops fixed with a section of a floss; and a handle having it distal end connected and secured to the end of the U-shaped holder. Depending on the fashion of connection between the handle and the U-shaped holder, dental flossers having already been published are divided into two types. Type 1 relates to a 2D dental flosser with its U-shaped holder and the handle located on the same plane, and the floss and the handle are also located on the same plane, as represented by U.S Pat. No. 5,692,531. Advantages of the 2D dental flosser include easy portability since both of the U-shaped holder and handle are located on the same plane; and comparatively lower production cost. Defective about the 2D dental flosser is that it is difficult to reach certain position between teeth when employed to clean the posterior oral cavity since the floss in not in parallel with the direction of the arrangement of slits between those teeth located in posterior oral cavity thus to affect the cleaning results. Type 2 relates to a 3D L-shaped dental flosser having its U-shaped holder and the handle in L-shaped construction (3D construction), i.e., not on the same plane; and the floss is vertical to the central axis of the handle as represented by U.S. Pat. No. 5,388,600. The 3D dental flosser provides advantage that the floss is always in parallel with the direction of the arrangement of the teeth anterior or posterior. That is, it could actually reach any slit between teeth to pay substantially thorough cleaning results. However, the L-shaped dental floss occupies comparatively larger space to compromise easy packaging and portability and a higher production cost is involved. In general, 2D dental flosser allows easier packaging and portability, and lower production cost; but it fails thorough cleaning results for those teeth in the posterior oral cavity. On the contrary, L-shaped dental flosser provides comparatively thorough cleaning results for those teeth anterior or posterior in the oral civility, but not so convenient for packaging and portability while its production cost is comparatively higher.

### SUMMARY OF THE INVENTION

The primary purpose of the present invention is to provide an L-shaped dental flosser that achieves comparatively thorough cleaning results while permitting easy packaging and portability, and lower production cost.

To achieve the purpose, a L-shaped dental floss in 2D construction is comprised of a U-shaped holder 22, a section of floss 11 secured and bridged between both distal ends of the U-shaped holder, and a left and a right handles 31, 32 respectively connected to the base of the U-shaped holder. Wherein, both distal ends from the left and the right handles 31, 32 are respectively connected to both sides at the base of the U-shaped holder, and a left hinge and a right hinge 41, 42 are respectively provided thereon. Both of the left and the right hinges are made thinner and allow easy bending so to permit both of the left and the right handles 31, 32 to respectively turn around the left and the right hinges to close in and contact each other. A left locking means 31 a and a right locking means 32a may be respectively provided to the left and the right handles 31, 32 for both of the left and the right handles to be tightly interlocked to each other. Both surfaces respectively from the left and the right handles 31, 32 are disposed with multiple ribs to increase the surface friction thereon. To make the present invention even more compact, both distal ends of the left and the right handles 31, 32 are connected to each other and a thinner and allowing easy bending tail hinge is provided at where the connection takes place.

In its non-use status of the present invention, the U-shaped holder 22 and both of the left and the right handles 31, 32 are located on the same plane to indicate a 2D construction. When in use, both of the left and the right handles are respectively turned around the left and the right hinges 41, 42 to close onto each other until their distal ends are in congruous status. Meanwhile, both of the left and the right handles, and the U-shaped holder indicate a 3D L-shaped construction. The user is allowed to use the dental flosser by merely holding both of the left and the right handles to operate the floss 11 secured and bridged between both distal ends of the U-shaped holder. With the use of hinge for the connection, both of the left and the right handles 31, 32 are able to respectively turn around the left and the right hinges 41, 42 to close in and contact each other thus for the present invention to shift between 2D plane and 3D L-shaped constructions. That is, when the present invention is in its non-use status, it indicates a plane 2D construction; and when in use, it indicates a 3D L-shaped construction. As a result, the present invention provides the advantages including easy packaging and portability, lower production cost found with the 2D dental flosser and comparatively more thorough cleaning results since the floss could reach any teeth slit in the oral cavity as observed with the L-shaped dental flosser at the same time.

A left locking means 31a and a right locking means 32a are respectively disposed to both of the left and the right handles 31, 32 to tightly interlock both of the left and the right handles 31, 32 to each other for providing an even stable use of the present invention. Multiple ribs 3b are provided on each surface of the left and the right handles 31, 32 to increase friction thereon for a firm holding of the present invention in use. Furthermore, both distal ends of the left and the right handles 31, 32 are connected to each other, and a thinner and allowing easy bending tail hinge is provided thereon for providing a more compact construction and better use of the present invention.

### BRIEF DESCRIPTION OF THE DRAWINGS

FIG. 1 is a schematic view showing a construction of a 2D dental flosser of the prior art.

FIG. 2 is a schematic view showing a construction of a 3D L-shaped dental floss.

FIG. 3 is a schematic view showing a first preferred embodiment of the present invention in non-use status.

FIG. 4 is a schematic view showing the first preferred embodiment in its use status.

FIG. 5 is a schematic view showing a second preferred embodiment of the present invention in non-use status.

FIG. 6 is a schematic view showing the second preferred embodiment in its use status.

FIG. 7 is a schematic view showing a third preferred embodiment of the present invention in non-use status.

FIG. 8 is a schematic view showing the third preferred embodiment in its use status.

FIG. 9 is a schematic view showing a fourth preferred embodiment of the present invention in non-use status.

FIG. 10 is a schematic view showing the fourth preferred embodiment in its use status.

FIG. 11 is a schematic view showing a fifth preferred embodiment of the present invention in non-use status.

FIG. 12 is a schematic view showing the fifth preferred embodiment in its use status.

FIG. 13 is a schematic view showing the front of a sixth preferred embodiment of the present invention in its non-use status.

FIG. 13a is a magnified view of a partial breaking away taken from the dotted area 81 in FIG. 13 of the sixth preferred embodiment of the present invention.

FIG. 13b is a magnified view of a partial breaking away taken from the dotted area 82 in FIG. 13 of the sixth preferred embodiment of the present invention.

FIG. 14 is a schematic view showing the back of the six preferred embodiment of the present invention in its non-use status.

FIG. 15 is a schematic view showing the construction of the sixth preferred embodiment of the present invention in its use status.

FIG. 15a is a magnified view of a partial breaking away taken from the dotted area 83 in FIG. 15 of the sixth preferred embodiment of the present invention.

FIG. 16 is a schematic view showing a construction of a left locking means of the sixth preferred embodiment of the present invention.

FIG. 17 is a schematic view showing a construction of a right locking means of the sixth preferred embodiment of the present invention.

### DETAILED DESCRIPTION OF THE PREFERRED EMBODIMENTS

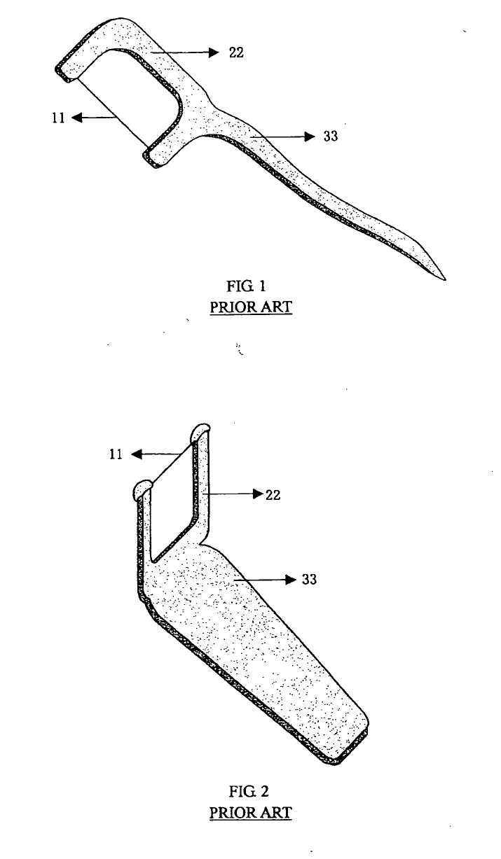

Referring to FIG. 1 for a schematic view of a construction of a 2D dental flosser of the prior art, it includes a U-shaped holder 22 with its both distal tops fixed between a section of a floss 11; and a handle 33 with its front end connected and secured to the base of the U-shaped holder 22. Both of the U-shaped holder and the handle 33 are located on the same plane while both of the floss 11 and the handle 33 are also located on the same plane. Since both of the U-shaped holder 22 and the handle 33 are located on the same plane, the 2D dental flosser provides advantages of easy packaging and portability, and lower production cost; however, the cleaning results of the 2D dental flosser is compromised by that it is difficult to reach to clean those teeth in the posterior oral cavity since the floss 11 is not in parallel with the direction of the arrangement of the slits between those posterior teeth in the oral cavity.

FIG. 2 shows a schematic view of a construction of a 3D L-shaped dental flosser of the prior art. It is essentially comprised of a U-shaped holder 22 with its both distal ends secured with a section of a floss 11; and a handle 33 having its front end connected and secured to the base of the U-shaped holder 22. The relation between the U-shaped holder 22 and the handle 33 indicates an L-shaped construction and is not on the same plane. The floss 11 is vertical to the central axis of the handle 33. The L-shaped dental flosser provides the advantage of comparatively more thorough cleaning results since the floss for being in parallel with that direction of the arrangement of the slits between teeth, anterior or posterior in the oral cavity is capable of reaching any slit between teeth. However, the flaws of the L-shaped dental flosser include higher production cost, and difficult packaging and portability since it occupies larger space.

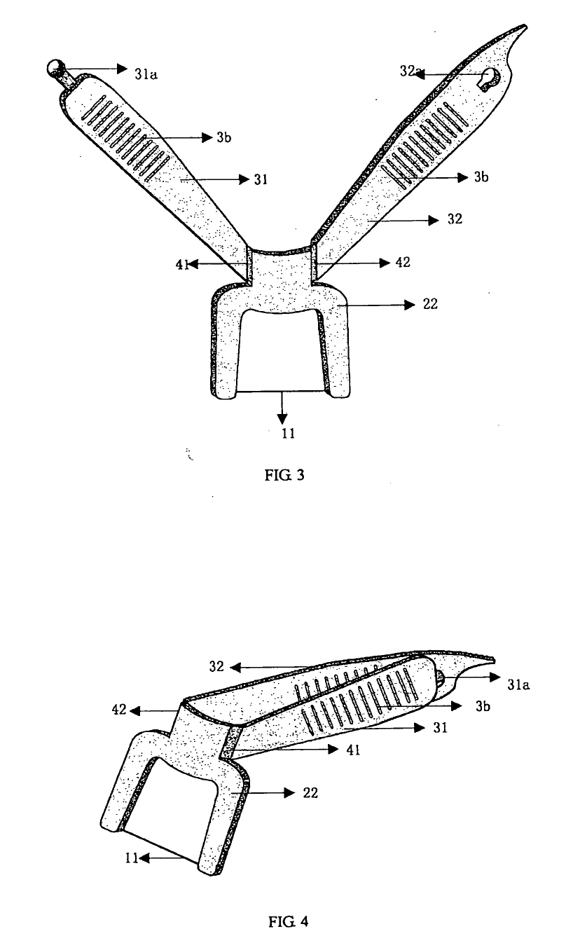

As illustrated in FIG. 3, a first preferred embodiment of the present invention in its non-use status is comprised of a U-shaped holder 22 having between its distal ends fixed with a section of a floss 11; a left handle 31, and a right handle 32 with both handles 31, 32 respectively connected to the base of the U-shaped holder 22. Wherein, both front ends of the left handle 31 and the right handle 32 are respectively connected to both sides at the base of the U-shaped holder 22, and a left hinge 41 and a right hinge 42 are respectively disposed at where both handles 31, 32 are connected to both sides at the base of the U-shaped holder. Both of the left and the right hinges 41, 42 are made thinner and easier to be bent so to allow both of the left and the right handles 31, 32 to respectively turn around on the left and the right hinges 41, 42 and to get closer to contact each other.

Furthermore, a left locking means 31a is provided at the distal end of the left handle 31. The left locking means 31a includes a ball, and a narrower and thinner band connecting the ball. Another end of the band is connected to the distal end of the left handle 31. Meanwhile, a right locking means 32a is disposed to the right handle 32. The right locking means 32a includes a round hole, and a gap is provided at the front edge of the round hole. The diameter of the round hole of the right locking means 32a is slightly smaller than that of the ball disposed to the left locking means 31a.

It should be appreciated that other types of the locking means can be used as long as a set of proper locking means is divided into two matching parts to be respectively disposed at where appropriately on the left and the right handles 31, 32 and both matching parts are able to be locked to each other thus to tightly fasten both of the left and the right handles 31, 32 for use.

Multiple ribs 3b are disposed on the surfaces of the left and the right handles 31, 32 to increase the friction thereon. As a result, the user of the present invention could firmly hold both of the left and the right handles 31, 32 in cleaning his/her teeth.

A tiny and sharp tail is disposed at the distal end of the right handle 32 to function as a toothpick or massage the gum.

As illustrated in FIG. 3, when the first preferred embodiment is not in use, all the U-shaped holder 22, both of the left and the right handles 31, 32, and both locking means 31a, 32a are located on the same plane to indicate a 2D construction to provide the same advantages, easy packaging and portability, and lower production cost as that given by the 2D dental flosser of the prior art

FIG. 4 shows the first preferred embodiment in use. Wherein, both of the left and the right handles 31, 32 are respectively turned around the left and the right hinges 31, 32 to get closer to each other until both distal ends of the left and the right handles 31, 32 touch each other. Apply force to press the ball of the left locking means 31a into the round hole of the right locking means 32a to interlock both of the left and the right locking means 31a, 32a, and thus both of the left and the right handles 31, 32. When both of the left and the right handles 31, 32 are interlocked to each other, the left handle 31, the right handle 32, and the U-shaped holder 22 indicate an L-shaped construction. The user merely holds both of the left and the right handles 31, 32 to operate the floss 11 bridged between both distal ends of the U-shaped holder to clean his teeth. The first preferred embodiment in use appears to provide the advantage found with the 3D L-shaped dental flosser of the prior art to reach any slit between teeth to facilitate comparatively more thorough cleaning results.

In the first preferred embodiment of the present invention, it is characterized by the construction of dual handles 31, 32 and the connection means provided by both mobile hinges (41, 42) for the first preferred embodiment to make shifts between 2D and 3D L-shaped constructions of the dental flosser. In its non-use status, the first preferred embodiment indicates a 2D construction, and in use status a 3D construction. As a result, the present invention provides the advantages of the 2D and the 3D L-shaped dental flossers at the same time.

Generally, either in location or direction, both of the left and the right hinges 41, 42 are arranged in symmetric in relation to the central axis of the U-shaped holder 22. However, a controlled asymmetric arrangement is permitted. Given with the symmetric arrangement, an included angle defined by the left hinge 31 and the central axis of the left handle 31 is equal to that defined by the right hinge 42 and the central axis of the right handle 32. The included angle is a very important technical index since it directly determine the included angle defined by the U-shaped holder and both of the left and the right handles 31, 32. In general, a degree of 110˜115 is preferred for the included angle; and any included angle greater or smaller than that preferred degree would compromise the use of the present invention.

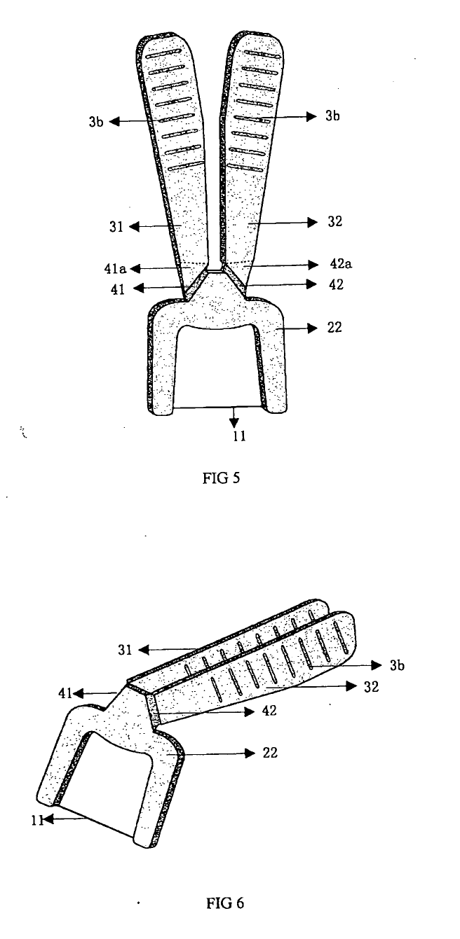

FIG. 5 shows a second preferred embodiment of the present invention in its non-use status. When compared to the first preferred embodiment, the second preferred embodiment essentially differs in the following aspects:
(1) In terms of the relation with the U-shaped holder 22, both of the left and the right handles 31, 32 of the second preferred embodiment are different from that of the first preferred embodiment either in location or direction. In practice, the present invention allows quite a great range of changes for the location and direction of both of the left and the right handles 31, 32, and that permits more options for the manufacturers in the design of the appearance of a dental flosser as desired.
(2) Both of the included angles respectively defined by the left hinge 31 and the central axis of the left handle 31, as well as by the right hinge 42 and the central axis of the right handle 32 are also different from those found with the first preferred embodiment. In practice, the present invention permits a wider range of changes for the included angle.
(3) Both of the left and the right hinges 41, 42 are not in parallel with each other in the second preferred embodiment. Accordingly, a torque developed when both of the left and the right handles 31, 32 are closing on each other will affect smooth use of the present invention. To solve this problem, a triangular area 41a closer to the vicinity of the left hinge 41 and another triangle area 42a closer to the vicinity of the right hinge 42 are made thinner for both triangular areas 41a, 42a to properly twist when subject to force applied when both of the left and the right handles 41, 42 are closing on each other, thus to reduce the torque applied upon both of the left and the right handles 31, 32.
(4) Both of the left and the right locking means 31a, 32a are omitted in the second preferred embodiment to permit simple construction. In use, the user has his fingers to firmly hold both of the left and the right handles 31, 32 to such extent that they are contiguous to each other as illustrated in FIG. 6.

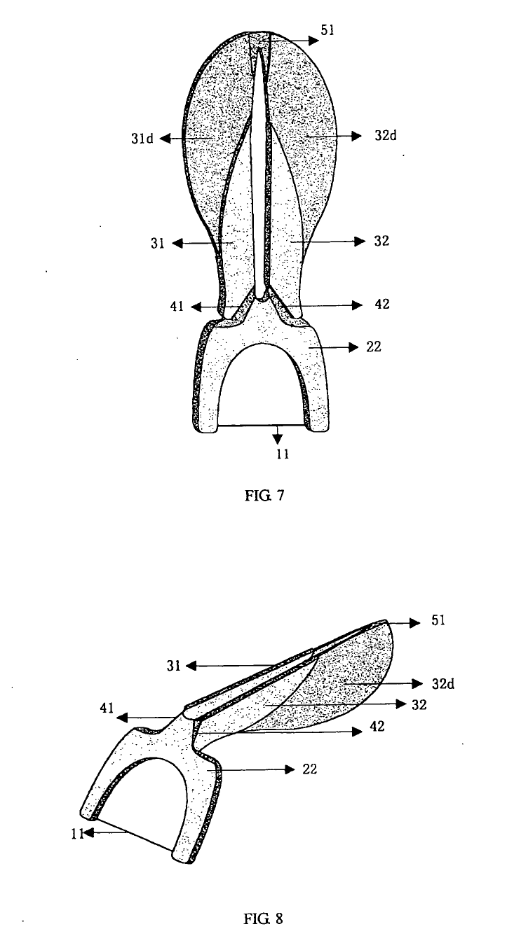

FIG. 7 shows a third preferred embodiment of the present invention in its non-use status. When compared to the second preferred embodiment, the third preferred embodiment essentially differs in that both distal ends respectively from the left and the right handles 31, 32 are connected to each other and a hinge 51 which is thinner and allowing easier bending is provided at the tail of the connection; that the shape respectively of the left and the right handles 31, 32 is different from that found with the second preferred embodiment; and that an rear area 31d and another rear area 32d are respectively provided to the left and the right handles 31, 32. Both of the rear areas 31d, 32d are made thinner to allow easy twist to facilitate closing on each other in use.

As illustrated in FIG. 8 when the third preferred embodiment is in use, both of the left and the right handles 31, 32 as well as both the rear areas 31d, 32d respectively of the left and the right handles 31, 32 are laterally pressed for them to respectively turn around the left hinge 41, the right hinge 42, and the tail hinge 41 until both rear areas 31d, 32d are closing on each other. The user merely holds both of the left and the right handles 31, 32 as well as both rear areas 31d, 32d to operate the dental flosser of the present invention. When compared to the second preferred embodiment, the third preferred embodiments features more compact construction, and easier operation of both handles.

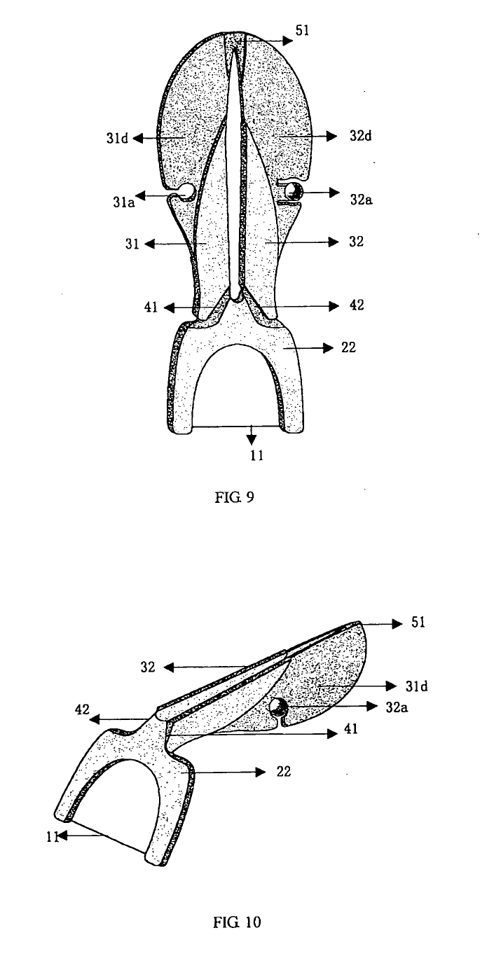

FIG. 9 shows a fourth preferred embodiment of the present invention in its non-use status. When compared to the third preferred embodiment, the fourth preferred embodiment is essentially improved in that a left locking means 31a is disposed to the rear area 31d of the left handle 31, and a right locking means 32a is disposed to the rear area 31d of the left handle 31. In use, press the ball adapted to the right locking means 32 into the round hole disposed at the left locking means 31a. As a result, both of the left and the right locking means 31a, 32a are interlocked to each other, thus both of the rear areas 31d and 32d are interlocked to each other.

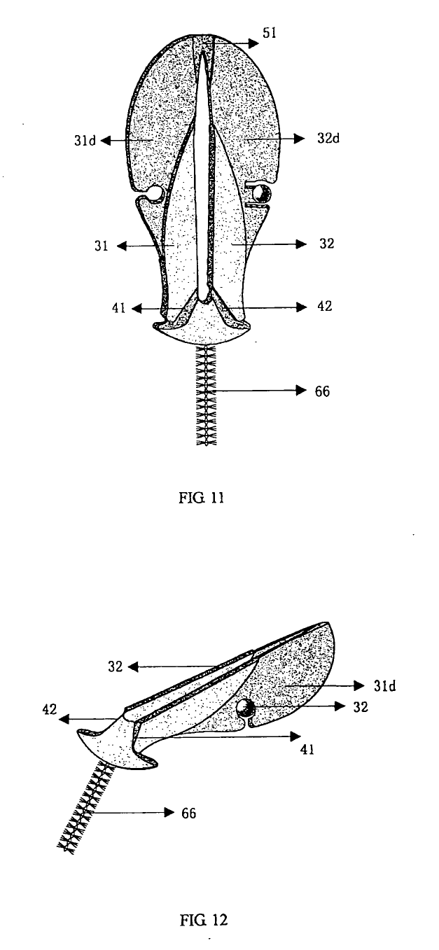

FIG. 11 shows a fifth preferred embodiment of the present invention in its non-use, and FIG. 12, in its use status. When compared to the fourth preferred embodiment, an improvement achieved by the fifth preferred embodiment essentially rests in that the U-shaped holder 22 is replaced with a head adapted with a teeth slit brush 66 sufficiently to indicate that the construction of the present invention is not limited to the application in a dental flosser, it can be further applied in other products including the teeth slit brush.

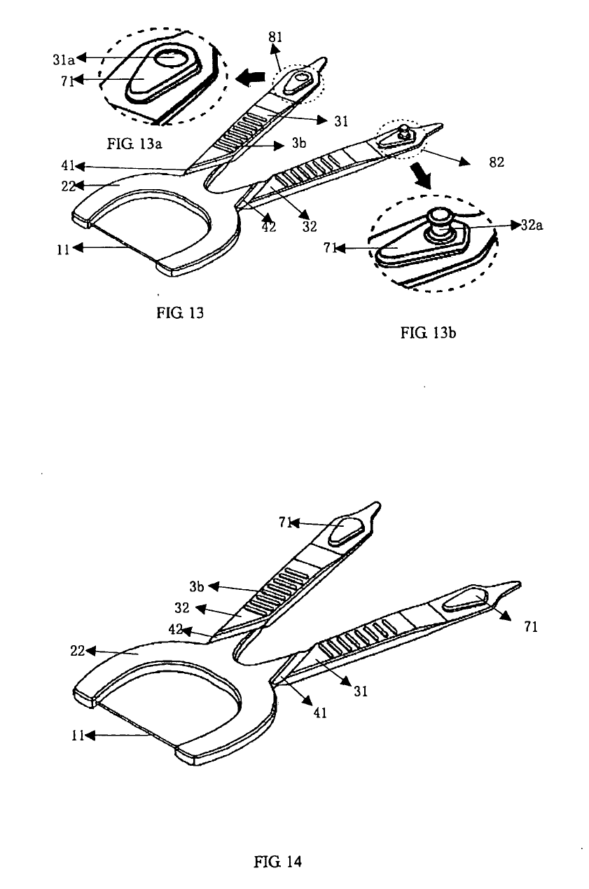

FIG. 13 is a front view of a sixth preferred embodiment of the present invention in its non-use status. FIGS. 13a and 13b respectively show the magnified views taken from the dotted areas in FIG. 13. When compared to the first preferred embodiment 1, the sixth preferred embodiment achieves the improvement essentially in that a projection 71 is each provided on the left and the right handles 32 at where approaches their distal ends, and that a locking means 31a is provided at the projection 71 on the front surface of the left handle 31. The left locking means 31a relates to a cylindrical hole with a slightly reduced central part. Meanwhile, a right locking means 32a is provided at the projection 71 on the front surface of the right handle 32. The right locking means 32b relates to a cylindrical rod having a slightly thicker top.

FIG. 14 shows the back of the sixth preferred embodiment of the back sixth preferred embodiment in its non-use status. Wherein, the projection 71 is also each disposed at where close to the tail of the left and the right handles 31, 32 but without any locking means thereon.

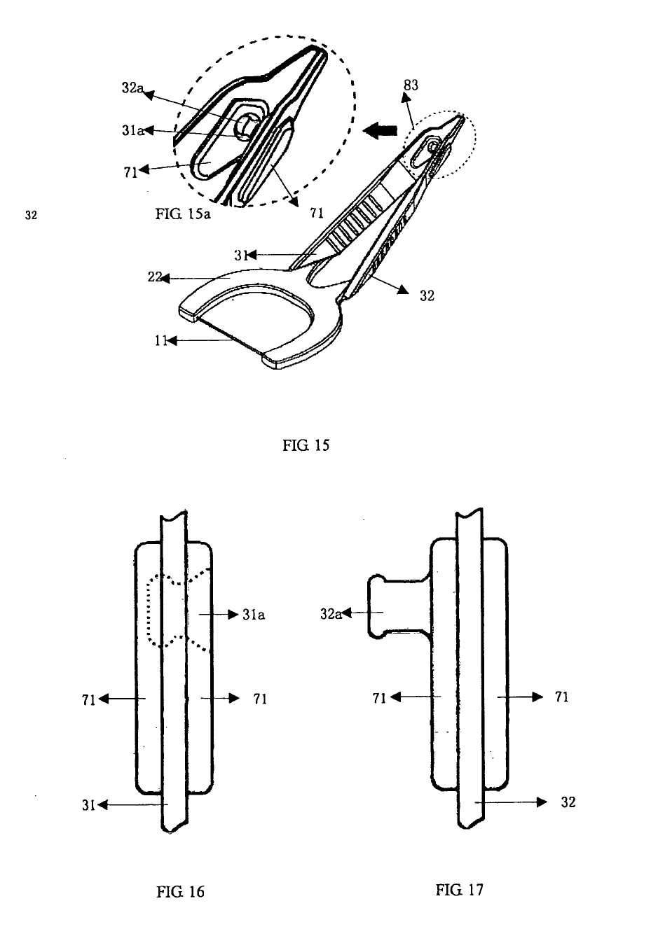

FIG. 15 shows the sixth preferred embodiment in its use status with the right locking means buckled into the left locking means 31a. FIG. 15a shows the magnified view taken from the dotted area in FIG. 15. By turning both of the left and the right handles 31, 32 to close them onto each other while having the right locking means 32a to be aligned at and pushed into the left locking means 31a so to interlock both of the left and the right handles to each other.

FIG. 16 is a side view of the left locking means of the sixth preferred embodiment. The left locking means 31a relates to a found hole having made slightly thinner at its central part. FIG. 17 shows the side view of the right locking means 32a. The right locking means 32a relates to a cylindrical rod having a slightly thicker top. The sixth preferred embodiment may be plastic cast. When the right locking means 32a is buckled into the left locking means 31a without impedance since the plastic gives proper resilience disregarding the fact that the top of the right locking means 32a is thicker than the central part of the left locking means 31a. When buckled up, the thicker top of the right locking means 32a is stopped by the thinner central part of the left locking means 31a for both of the left and the right locking means 31a, 32a to be tightly interlocked to each other.

It is to be noted that the present invention is simple in construction and reasonable in design to allow model injection with plastic material in one process, and thus is particularly perfect for one-step production on commercial scale.

1. A plane L-shaped dental flosser is comprised of a U-shaped holder, a section of floss 11 bridged and secured between two distal tops of the U-shape holder, a left handle, and a right handle with both handles respective connected to the base of the U-shaped holder; wherein both front ends from the left and the right handles are respectively connected to both sides at the base of the U-shaped holder; a left hinge and a right hinge are respectively provided at where the connection is located; both of the left and the right hinges are made thinner and allowing easy bending; and both of the left and the right handles respectively turn around the left and the right hinges to close onto and contact each other.

2. The dental flosser of claim 1, wherein a left locking means and a right locking means are respectively disposed on the left and the right handles to tightly interlock both of the left and the right handles to each other.

3. The dental flosser of claim 1, wherein the surface each on the left and the right handles is provided with multiple ribs to increase the friction thereon.

4. The dental flosser of claim 1, wherein both ends respectively from the left and the right handles are connected to each other; and a tail hinge that is thinner and allows easy bending is provided at where the connection is made between both ends of the left and the right handles.
